(19) United States
(12) Patent Application Publication
(10) Pub. No.: US 2011/0067157 A1
(43) Pub. Date: Mar. 24, 2011

(54) Method and apparatus for Variable G force experience and creating immersive VR sensations

(76) Inventor: QUAN XIAO, Markham (CA)

(21) Appl. No.: 12/885,510

(22) Filed: Sep. 19, 2010

Related U.S. Application Data
(60) Provisional application No. 61/277,145, filed on Sep. 19, 2009.

(51) Int. Cl. B64G 6/00

(52) U.S. Cl. 2/2.11

(57) ABSTRACT

The present invention relates to variable low/zero gravity simulation systems. variable low/zero gravity condition is achieved by substantial immersion in a fluid environment (“buoyancy means”) and using power assist means/robotic displacement devices such as exoskeleton to help user's movement/gravity compensation and/or relief or change loads on the subject's torso and limbs that caused by the weight and shape of the “Buoyancy means”, so that user can experience the effect of the (variable) gravity environment being simulated, such as Zero gravity in which situation user could move effortlessly in a weightless environment. When combine with VR related technology, this can create vivid immersive simulations for extraterrestrial scenes and can be widely used for entertainment, game, training, healing and etc.

### CROSS REFERENCE TO RELATED APPLICATIONS

The present application claims priority from U.S. Provisional Patents Application Ser. No. 61/277,145 filed Sep. 19, 2009, the full disclosures of which are hereby incorporated by reference herein.

### TECHNICAL FIELD

The present invention relates to variable low/zero gravity simulation systems. variable low/zero gravity condition is achieved by substantial immersion in a fluid environment (“buoyancy means”) and using power assist means/robotic displacement devices such as exoskeleton to help user's movement/gravity compensation and/or relief or change loads on the subject's torso and limbs that caused by the weight and shape of the “Buoyancy means”, so that user can experience the effect of the (variable) gravity environment being simulated, such as Zero gravity in which situation user could move effortlessly in a weightless environment. When combine with VR related technology, this can create vivid immersive simulations for extraterrestrial scenes and can be widely used for entertainment, game, training, healing and etc.

### BACKGROUND ART

Traditionally, Zero gravity or low gravity simulation for more than a few seconds on earth is difficult and expensive. NASA, for example, uses different methods for simulation including using an airplane to fly a trajectory path, or using underwater pressurized space suit. While these methods are effective in training astronauts, they have certain limitations and special trainings for user are usually required to ensure safety. So these methods are still costly for public use for example in the fields of entertainment.

Neutral buoyancy underwater training is also a known technique that is employed for its ability to provide micro-gravity environment training on earth. Such training systems are used in connection with underwater laboratories for training astronauts.

Power assist means/robotic displacement devices such as exoskeleton are more and more common these years thanks to technological advancements in sensor, computing and motor/actuator devices. As demonstrated by patent application WO2005099398 , Patent application WO2008094191 and patent CN101357097 there are also known techniques for using/controlling power assist means/robotic displacement devices such as exoskeleton to assist user movement and/or for gravity compensation.

### SUMMARY OF THE INVENTION

Neutral buoyancy training is used by NASA for training astronauts for EVA (a.k.a. space walk), and it proves to be an realistic and effective way of simulating low gravity conditions. However this requires submerge user in a water tank and pressurize the spacesuit he/she is wearing. This requires special training and safety measures to be taken to prevent diving related risks to user. While in static situation the weight of the user are compensated by the buoyancy, the “viscosity” of the water will create drag/friction when user moving around, which makes it feels differently than in space where there's no drag in the vacuum environment in space. Also by submerging user in a big water tank creates some challenges to provide realistic visual environments (which is important to purposes like entertainment and visual simulation) since the water absorbs light heavily and unevenly in the viewable spectrum, thus make it difficult to provide white balanced picture when seeing thru the water over a distance.

The current invention, by surrounding user's body (but not in front of user's eyes) with a layer of fluid/mixture in a “buoyancy means/environment” (possibly a suit like environment), can solve the difficulties mentioned above. Just like neutral buoyancy training, the user is able to “float” inside the suit environment, but simplifying the process and eliminating the danger of drawing, since user's head is not submerged user water. Further more user do not need to see thru water to get the visual signal in many virtal reality/simulation/training and game situations, so the visual display, such as mockup and/or screen for video signals, can be placed far away from user to create correct distance feeling as in space, and much more simpler to operate than that within an underwater environment.

The weight of the suit itself, however, needs to be supported. If user has to support the weight of the suit, for example when he is standing, or trying to move the arm or leg, it will feels heavy because of the weight of buoyancy means (which could be in a suit shape). A power assisting means/robotic displacement device(s), such as but not limited to exoskeleton, which can compensate the gravity force needed to perform the tasks (and possibly other forces/inertia etc.), can be used to solve this problem. These devices usually can “mimic” users pose changes/limb movements, and/or “magnify” user's power, and in some cases “wearable”. Thus it can be quite convenient to integrate with the above mentioned “buoyancy means” (possible to be suit like), and the combined system might still possible to be fitted in a larger suit. An example is shown in Picture 1.Some of the “wearable” exoskeletons is shaped close to human shape/figure, it will be not difficult to place it in side a “space suit” (or figure of a creature or species that bear resemblance with human figure) shaped cover, and make the whole system looks like a real space suit (or the figure). For other situations, Virtual Reality or Mixed reality technology can help, as discussed later in the specification.

In a first embodiment of the invention, apparatus for Variable G force experience and create immersive VR sensations comprise of:

A “Buoyancy means” which utilizing fluid or mixture of fluids for body weight support of the subject, such “Buoyancy means” has a flexible inner surface/layer which is relatively impermeable to the fluid/mixture of fluids being used and covers or “wraps” substantially the subject's whole body area. It also has at least one outer surface layer to hold or to “contain” the fluids or mixture of fluids that used to “float” the subject inside the inner layer. The shape of the outer layer can be but not limited to suit shape or partially like suit shape. There could be multiple compartments to contain the fluids/mixture within the 2 surfaces/layers. Substantial area of inner layer should be able to provide fluid pressure to the subject.

A “power assist means” or “robotic displacement device” for subject, (such as but not limited to an exoskeleton) that integrate/couple with said “Buoyancy means” to help subject's movement/activity and/or relief or change loads on the subject's torso and limbs that caused by the weight and shape of the “Buoyancy means”, this could be in form of such as but not limited to gravity compensation, different G-force effect simulation and etc, when subject occupies the “buoyancy means”.

In a related embodiment, the “buoyancy means” can have multi part and individual parts optionally can be filled, drained and/or pressurized separately.

In an other related embodiment, fluid between the inner layer and outside layer can be moved in and out, and could be dynamically during the period of simulation.

In an other related embodiment, the “buoyancy means” and robotic displacement/power assist devices can be made into appropriate size and shape, and being fitted into a larger outer suit/figure which can look like for example but not limited to a space suit, a figure of species or creature bearing resemblance with human shape, and etc..

In an other related embodiment, virtual reality systems, augmented reality systems or mixed reality systems (including display means, image processing unit, possible image capture devices and etc.) can be combined together with the buoyancy means and power assist means, to provide synchronized visual and audio experience to the subject that is consistence with the scene/situation/environment that the buoyancy system and power assist system is simulating.

In an other related embodiment, that Buoyancy means and power assisting means can further integrated the with game controller, manipulator or other user input device for the purpose such as but not limited to game, training, entertainment, simulation, healing and etc.

In an other related embodiment, the “power assist means” or “robotic displacement device” can be used to produce (additional) tactile or force feedback to the user by providing physical sensations to the user. Coordinated by the controlling unit of the “power assist means” or “robotic displacement device”, by changing for example (but not limited to) the factors/percentages of gravity compensation, possibly dynamically, variable G force feeling can be achieved. Other forms such as vibration and “resisting” force can be achieved by for example changing the output of the “power assist means” or “robotic displacement device” on one or more actuators.

In an other related embodiment, force feedback can also be achieved by varying/changing the pressure of different compartment of the Buoyancy means.

In an other related embodiment, additional tactile devices as well as motion sensors on or near user's body can be used to increase the accuracy and/or fun of the force feedback sensation.

An method to provide user with variable G force experience and create extraterrestrial sensations, the method comprising:

Having user don an “Buoyancy means” that support for his/her body weight by the pressure/buoyancy generated by the fluid/mixture of fluids, such “Buoyancy means” has a flexible inner surface/layer which is relatively impermeable to the fluid/mixture of fluids being used and covers or “wraps” substantially the users whole body area. It also has at least one outer layer/surface to hold or to “contain” fluids/mixture that used to “float” the subject inside the inner layer. The shape of the outer layer can be but not limited to suit shape or partially like suit shape. There could be multiple compartments to contain the fluids/mixture within the 2 surfaces/layers. Substantial area of inner layer should be able to provide fluid pressure to the subject. While user occupies such “Buoyancy means” environment, using a “power assist means” or “robotic displacement device” (such as but not limited to exoskeleton) to help user's movement/activity, or to relief or change loads on the subject's torso and limbs that caused by the weight and shape of the “Buoyancy means”, such as but not limited to providing gravity compensation, simulating different G-force effect or providing force feedback and etc, such “power assist means” is couple-able with the “Buoyancy means”.

In an other related embodiment the method comprising making the “buoyancy means” multi part, and filling, draining and/or pressurizing individual parts.

In an other related embodiment fluid can be moved in and out of the space between the inner layer and outside layer, possibility dynamically.

In an other related embodiment the “buoyancy means” and robotic displacement/power assist devices can be fitted into a larger outer suit which can look like for example but not limited to a space suit, a figure of species or creature bearing resemblance with human shape, and etc.

In an other related embodiment, virtual reality systems, augmented reality systems or mixed reality systems (including display means, image processing unit, possible image capture devices and etc.) can be integrated with the buoyancy means and power assist means, to provide synchronized visual and audio experience to the subject that is consistence with the scene/situation/environment that the buoyancy system and power assist system is simulating.

In an other related embodiment the method comprising integrating buoyancy means and power assisting means with game controller, manipulator or other user input device for the purpose such as but not limited to game, training, entertainment, simulation, healing and etc.

In an other related embodiment the method comprising producing (additional) tactile or force feedback to the subject by providing physical sensations to the subject with the “power assist means” or “robotic displacement device”. Coordinated by the controlling unit of the “power assist means” or “robotic displacement device”, by changing for example (but not limited to) the factors/percentages of gravity compensation, possibly dynamically, to achieve variable G force effect (sensation) to the subject. And/Or, for example by changing the output of the “power assist means” or “robotic displacement device” on one or more actuators to provide other forms such as vibration and/or “resisting” force to subject.

In an other related embodiment the pressure of different compartment of the buoyancy means can be varied/changed to achieve force feedback to subject.

In varying/changing additional tactile devices as well as motion sensors on or near user's body can be integrated to increase the accuracy and/or fun of the force feedback sensation.

### BRIEF DESCRIPTION OF THE DRAWINGS

The foregoing features of the invention will be more readily understood by reference to the following detailed description, taken with reference to the accompanying drawings, in which:

FIG. 1 Shows in accordance with an embodiment of the present invention, the user wearing a suit like buoyancy means 101 (with an optional hose 110 that can be used for moving fluid in and out of the suit). The buoyancy means can be connected to exoskeleton 102. With means such as (but not limited to) braces/harness 103, sections of exoskeleton connect to the corresponding parts of the suit and support/compensate the weight. It is possible to put an “outer suit”, for example a suit similar to the exterior of a space suit (and possibly together with helmet) on top of the combined systems, so looking from outside it looks like a real space suit, and when user wearing it, it feels like in the Zero-G environment.

FIG. 2A is a cross-section view taken along line A-A of FIG. 1. This figure illustrates the outer layer 56 and the inner layer 54 of the inner suit 52, the layers 54,56 being separated by a layer of liquid/fluid 58. Both layers 54,56 of the inner suit 52 may be formed of a material at least substantially impermeable to the fluid/fluid mixture used.

FIG. 2B shows the simulation space suit design in a half-profile view, outer layer 56 of the buoyancy system and the inner layer 54 being separated by a layer of fluid/mixture 58. 201 is the outer most layer which can be made similar to a space suit exterior, with helmet 202, and possibly containing the supporting exoskeleton inside. Optionally, some (solid) resilient cushion material 206 such as foam or rubber can be added to sections of limb sections, so that they can 1) make the limb manipulate the exoskeleton easily. And 2) stop or slow down the possible fluid movement when user moving or changing pose.

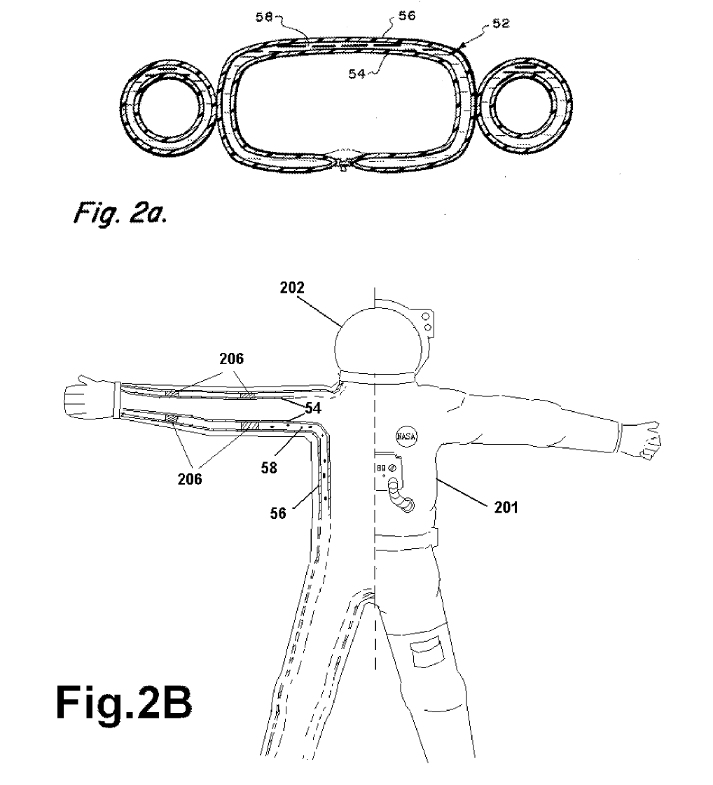

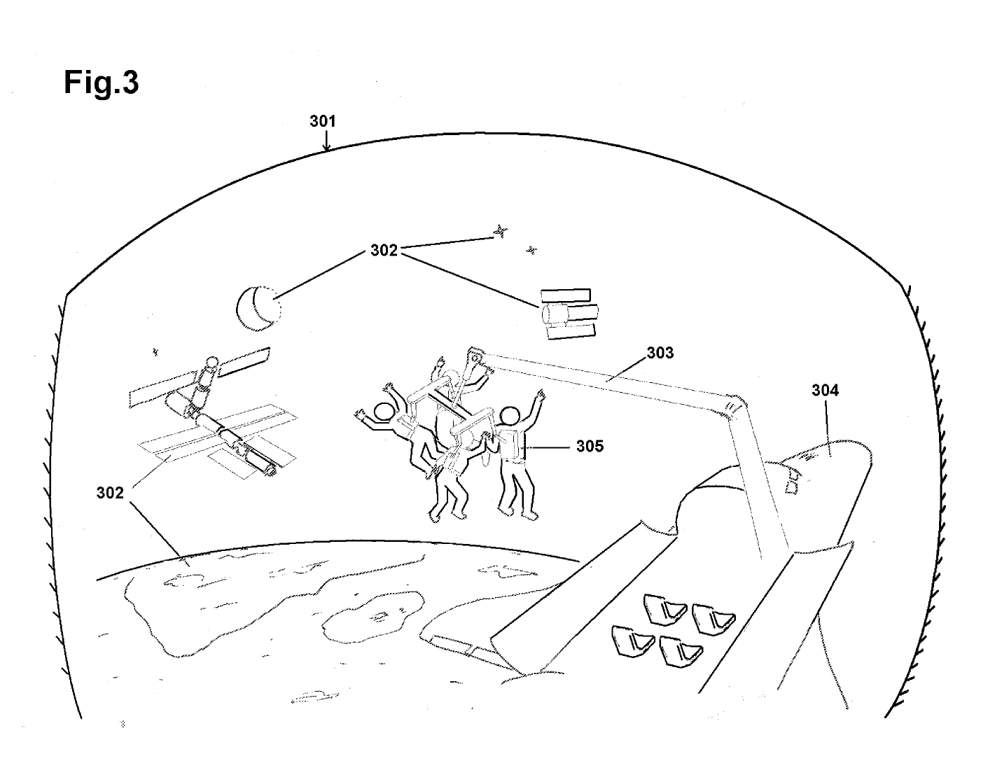

Because user's limb is going to interact with the exoskeleton/power assisting means, and certain kind of exoskeleton use the force sensors on the frame to determine user's intention of movement, so in certain situations a little bit of force needed to be put on those sensors in order to manipulate them (this is dependent on the specific design of the exoskeleton/power assisting means). Because the suit like buoyancy system could be soft and can change shape when pressed on to a hard object like the frame, it is not as convenient and accurate to manipulate it as when user is not wearing such suit. In situations like this, it is desirable to make certain part of the buoyancy system relatively more “rigid” (rather than soft and baggy, but could be still resilient), by means for example adding solid resilient/cushion materials such as but not limited to rubber, foam and etc, between inner layer and outer layer like depicted in FIG. 2B, so that user's movement can be more accurately passed to the sensors on the exoskeleton frame. These materials can also slowdown or even stop the movement of the liquid in the buoyancy system when user move his/her limb or change pose and help to make the simulation more realistic and measurements more accurate. They can also help to “shape” and support the relatively flexible buoyancy means. These “relatively rigid” areas does not cover a big percentage of the total area, and also they are made of resilient materials, so the general buoyancy feelings of user are not affected.

FIG. 3 shows users wearing the above mentioned simulated space suit 305 (buoyancy means integrated with power assist means) can be further placed/suspended into the VR environment by using support system such as robot arm 303 as depicted in FIG. 3, or other kind of hoist system/support system. Such system is capable of moving the groups around, mainly in areas encircled by the surrounding screen 301 (could be any appropriate shape such as a circular or dome shaped theater screen). It could also have multiple screens in the VR environment. Images 302 such as that of the earth, moon, stars and space stations, satellites can be displayed on the screen 301. Mockups such as those of the space shuttle (304 in FIG. 3) can also be used. User wearing the simulated “space suit” can be given some degree of freedom of moving around, so that user can experience both weightlessness and the effortless feeling of movement, just like in a real space flight, in accordance with an embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

A “virtual reality system” is a computer-based system that presents to the user a virtual reality environment. The virtual reality environment is presented under conditions wherein the user is prevented from experiencing visual perceptions that are deemed inconsistent with the virtual reality environment. In particular, the virtual reality environment inhibits visual perception by the user of items outside of this environment, by for example presenting visual experience of the environment via a head mounted display that blocks viewing the ambient environment. Alternatively, the visual experience may be presented on one or more displays mounted on one or more surfaces at a distance from the user, under conditions where viewing the ambient environment is inhibited by shrouding anything that may be viewed in a location away from the displays in a sea of blackness, using, for example, black walls that are non-reflective. Often the virtual reality environment models a setting with respect to which a user is able to interact so that user input modifies the presentation of the setting to the user. The interaction may be provided in various forms such as via sensing head motion, user orientation, or via a game controller or sensing gesture of the user.

The proposed methods and apparatus in accordance with embodiments of the present invention for Variable G force experience may be provided for activities such as training, recreational or entertainment activities, or for therapeutic benefits. Such methods generally require providing a buoyancy system/means such as a suit shaped “fluid body weight support apparatus” and a system for providing power assist (to help user's limb and or body movement)/gravity compensation to the user when user in the buoyancy system.

As will be described with reference to the embodiments illustrated such methods and systems may consist of a variety of components.

1) The Buoyancy Means (Environment)

The buoyancy means/environment support said subject with buoyancy force(s), said buoyancy means including at least two layers of flexible material, each layer being relatively impermeable to a fluid being locatable in a space between said layers, said means (could be suit like) for fitting over substantially the entire subject, could including the subject's neck, said space covering substantially the entire area of the suit; Optionally, the buoyancy means can be multi-piece and each piece supports for one part of the body. For example it can contain separated sections for each arm, and sections for leg and torso. For each section the fluid is in separated compartment(s). It is possible that the compartments can be pressurized separately, but it is possible that connectors be used to be linked part of the compartments or all of them together so that they share the same pressure and can be adjusted together. It is possible that the pressure added to the fluid/mixture can adjusted to a certain value (can be either positive value, 0 or negative value) that is appropriate to the simulation G force requirements and buoyancy state requirements. (In some situation for example when simulating the changes of G force feeling/effects, this may require the system to provide certain pressure to certain part of body, in such situation, using different pressure-adjustable compartments would be a good choice.)

Different fluid/fluid mixture (For example but not limited to pure water, water with salt or other kind of solution, oil, gel, slurry, or foam when appropriate) may be used to provide different buoyancy/pressure, to be used for purposes such as but not limited to simulating different gravity situations. For example as oil has less density than water and thus provide less buoyancy per same volume, it can be used to simulate low gravity environments such as that on the moon, while water or solutions density close to that of human beings could provide neutral buoyancy that can be used for simulating Zero-G situations.

It is desirable that optionally, the liquid/fluid could be dynamically moving in and out (pumped in/drained out) of the buoyancy suit, and add positive or negative pressure.

Optionally, one or more layer of permeable material is between the user and the water tight envelope to absorb moisture and to provide passages for moisture clearing air to follow. The permeable material could provides thermal insulation between the water and the person and in co-operation with air forced through the permeable layer, permits the body's own temperature regulation system to function naturally.

Optionally, air from a compressor and flow regulating means is introduced into various parts of the suit, especially at the hands and feet, through tubes. Air flows through the permeable layer expelling air contaminated or fouled by, skin exudations (primarily perspiration) and other sources expelling them through the neck of the suit.

In the situation when the whole suit is pressed against the body by hydrostatic pressure (when the air pressure inside the inner does not balanced out or greater than the hydrostatic pressure by the fluid/mixture), a second inside layer (not illustrated) fashioned from a slippery fabric such as nylon tricot can be used to ease the effort required to move within the impermeable inner layer.

2. Power Assisting Means/Robotic Displacement Devices

It is well know that power assisting means/robotic displacement devices, such as exoskeleton, balancer, power steering devices and etc. are able to help user carrying out heavy duty tasks with minimum usage of muscle power of the operator.

Wearable exoskeleton is usually a device referring to a robotic frame shaped to approximate and be couple-able to at least a portion of the human body and configured to mimic movement with the human body. An example is the “robot displacement system” built by SARCOS as described in WO 2008094191. It have approximates the shape of the human body and is capable of mirroring human movement displacing multiple limbs of the exoskeleton frame concurrently and usually in real time via direct contact by the human operator without relying on predefined trajectory movements of the operator.

The device as mentioned in WO 2008094191 employs a plurality of linear and rotational force sensors which are attached to the robotic frame near the hands and feet of the frame. The sensors detect a baseline controlling interface force status relationship between the sensors and the extremities of the human operator, including a contacting relationship as well as a displaced, non-contacting relationship. The sensors then output a force signal to a computation system which is integrated into the robotic frame. Based on the output force signal from the sensors and the force and direction of gravity relative to the robotic frame, the computation system calculates a linear and rotational force required to maintain the controlling force status relationship. That system then generates and transmits an actuation signal to a drive system attached to the robotic frame. The drive system then displaces a portion of the robotic frame in order to maintain the controlling force status relationship. Alternatively, where no displacement is desired, but the load on the robotic frame has changed, the drive system increases the linear and rotational forces on the robotic frame as needed to maintain the controlling force status relationship.

For different pose and load exerted on user's limbs, the device is capable of compensate for the force caused by gravity acceleration (and possibly other forces/acceleration/inertia). Thus make user feeling effortless while moving/changing pose.

It is well known that there are many ways to control the robotic displacement/power assisting device to compensate for gravity force, as demonstrated in U.S. Pat. No. 7,390,309, US2006247904, CN101357097, and WO 2008094191. Also some devices might not call themselves as “exoskeleton”s, As the suitable means for the power assisting purposes may be embodied in a wide variety of forms, some of which may be quite different from those of the disclosed embodiment. Consequently, the specific structural and functional details disclosed and discussed herein are merely representative; yet in that regard, they are deemed to afford the best embodiment for purposes of disclosure and to provide a basis for the claims herein which define the scope of the present invention.

Power assisting devices and/or robotic displacement devices, as long as they are capable of providing stable power assist to user so that user can move with small amount of effort, can be considered candidates. Because even in the real space walk, astronauts will still need to overcome small amount of force when trying to move around, this is caused by the pressurized space suit and joints. So in this system, small amount of manipulation force (comparing to the total force needed) is allowed and it is not required that the power assisting means/robotic displacement devices to compensate 100 percent of the power/force needed in the movement.

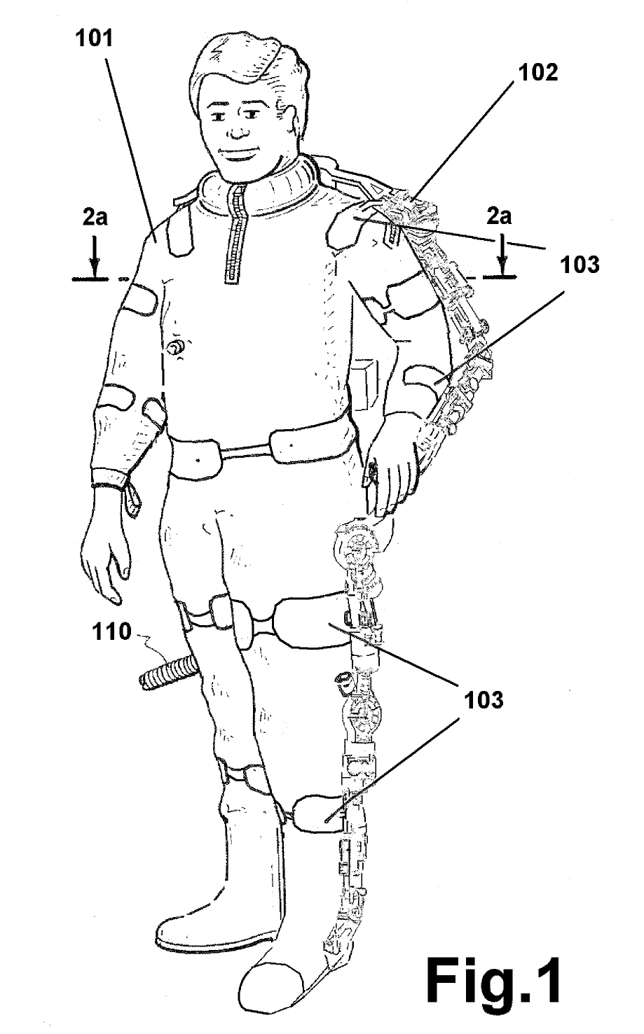

In many situations, because the buoyancy means wraps user's body like a suit (although it could be in multiple pieces) and can be considered “wearable” to user, the robotic displacement means/power assist devices (such as but not limited to exoskeleton) when integrated with the suit like buoyancy system (by means for example but not limited to using braces/harness as shown in FIG. 1), should be able to support the buoyancy system. Fro example in a way such as but not limited to: the way it would normally supports a people. For example the “upper extremity exoskeleton” part provide supports to the upper part of the buoyancy system which covers user's torso and arms, and the “lower extremity exoskeleton” part provide supports to buoyancy system which covers user's legs and etc. Other ways of support is also possible depending on the design of the buoyancy means, depending on factors such as rigidness of each part and the way how those parts are linked together.

It is also worth pointing out that in some form of embodiments it is not necessary for all limbs (or all major moving part of the body) getting power assisted by the “power assist means” or “robotic displacement device”. Using buoyancy for weight/gravity compensation for some of the limbs is also ok, for example, for some lower cost applications. One example will be, expand the outer layer of the buoyancy means, from maybe previously close to the shape of a suit to a shape that allow some of the limbs move freely in the fluid without interfere/touching the outside layer/surface. As an example, we can change the shape of the outer layer/surface of the lower part of the of the buoyancy system from something like a trousers to something like a ball with enough volumn, so that legs can move freely inside such ball like surface. Since the weight/gravity of this part of the body is compensated by the buoyancy of the fluid, the “lower extremity exoskeleton/power assist means” part can be omitted. Another example will be, immerse the lower part of the suit like buoyancy means in fluid thus using buoyancy to compensate the weight/gravity for this part. Such design is usually found in applications that do not expect this part of the body/limb to move a lot and rapidly, or for those requires accurate touch related feelings and/or precise control of limbs for accurate operations. (In which case the accuracy generally can not be achieved by using the power assist means/exoskeleton).

In some embodiments such as in the cases mentioned in the paragraph above, where the shape of the buoyancy means are not like a suit shape, or in other cases where the power assisting means are not close to the figure/shape of human, it will be very difficult or impossible to fit the combined system of buoyancy means and power assist means in to a “outer cover” that can be look like a space suit (or a figure of a creature/species bearing resemblance to human shape). In some other cases when using for example balancers, hoist like power assisting means or hydraulic cylinders/actuators (for purposes such as gravity compensation and ect.), the whole shape of the power assistance means is hardly resemble to “suit shape”, and thus not possible to fit them into a suit shape outer cover. In such cases, it is desirable to use Mixed reality (by default using HMD-head mounted display) or virtual reality using HMD to be used to block user from seeing such details that are inconsistence with the scenes being simulated, and instead seeing the visual signal provided by the MR or VR system that either filtered these insistency out (for MR) or void of such (real world) images by default (for VR). This could help to create a very realistic and immersive experience for user.

Optionally, to facilitate the possible requirements of fast get on and get off, the suit shaped buoyancy system, together with the robotic displacement device, can be separated to 2 or more parts, so that user can easy get in and get out with minimum help from outside. The parts then can be combined together for usage. For example it can be designed to have upper and lower parts, like the US EVA space suit design, or it can be like one piece with a “hatch” in the front or back for user to climb in, like the Russian Space suit design.

An Example of Immersive Simulation of Space Exploration

As we mentioned before a simulated space suit that contains the buoyancy system/means and the supporting exoskeleton/power assist means can be made. And together with virtual reality system, as depicted in FIG. 3, a very realistic immersive space tour simulation can be achieved. In FIG. 3, users wearing the above mentioned simulated space suit 305 can be placed/suspended into the VR environment by using support system such as robot arm as depicted in FIG. 3, or other kind of hoist system/support system. Such system is capable of moving the groups around, mainly in areas encircled by the surrounding screen 301 (could be any appropriate shape) such as a circular or dome shaped “theater” screen. It could also have multiple screens in the VR environment. Images 302 such as that of earth, moon and space stations can be displayed on the screen. Mockups such as those of the space shuttle (304 in FIG. 3) can also be used. User wearing the space suit can be given some degree of freedom of moving around, so that user can experience both weightlessness and effortless of movement similar to the sensation of flying, just like in a real space flight.

It is not only 0-G simulation that is possible for this invention. Coordinated by the controlling unit of the “power assist means” or “robotic displacement device”, by changing for example (but not limited to) the factors/percentages of gravity compensation, possibly dynamically, variable G force feeling can be achieved., Also pressure of the fluid to different compartment of the buoyancy means, as well as buoyancy status can be adjusted (for example using different kind of fluid/mixture with different density), these are some examples of achieving variable G sensation.

There are many benefits that the force to compensated the “G” force by the exoskeleton system/power assist means and the buoyancy system can be made adjustable (desirably dynamically), so that user might be experience different “G” force effects. One example will be simulating situation on the surface of the moon where the gravity force is one sixth of the earth surface. Another example would be that during take-off stage of the space shuttle, the crew will experience from normal 1G to 3-5G of overweight in powered ascending, and 0 G in orbit.

A “variable-G” system will be very useful in simulating these scenarios. The current invention make it quite easy to achieve such purpose. For example, for the buoyancy system, fluid/mixture can be pumped in and drained out to different sections that supports different parts of the body, Outside pressure can also be added to the fluid/liquid, these measure are able to give user different feeling of pressure which simulates the effect of G force. Using fluids/mixture of different density also changes the buoyancy forces provided so it is also a way of “varying” the simulated G force environment.

For many form of the robotic displacement means/power assist devices, for example for exoskeleton, usually the control system take into account of compensating G force acceleration in the control algorithm and can adapt to changes of gravity acceleration direction, as demonstrated in the patents mentioned above. The software algorithm can be made to compensate/simulate other similar force/acceleration also. One example will be to “reverse” compensation of the G force, instead of feeling weightlessness, user might feel “heavier than usual” when moving in the direction of acceleration, this will effectively simulate the 2G acceleration “overweight” sensation for user. As the implementation of the algorithm is varied from controller to another, the discussion here are merely representative. However it will be easy for people who is familiar the field to do so with given software algorism/source code.

Force feedback can also be achieved. The “power assist means” or “robotic displacement device” can be used to produce (additional) tactile or force feedback to the user by providing physical sensations to the user. Coordinated by the controlling unit of the “power assist means” or “robotic displacement device”, by changing for example (but not limited to) the factors/percentages of gravity compensation, or power assisting forces. And/Or for example changing the output of the “power assist means” or “robotic displacement device” on one or more actuators to achieve such as vibration and “resisting” force that might be required by the training/simulation/game.

It is also desirable that Buoyancy system (1) and power assisting means (2) can further integrated the with game controller/manipulator or other form of user input device, as well as itself can be used as game input device and output device, to create more vivid simulation and new sensation of training/game. And this can be further integrated with Virtual Reality/Mixed Reality systems.

Another advantage of the system is that by gathering pose information from robotic displacement device/power assist means (such as an exoskeleton), and/or from outside sensors, and/or using a manipulating means by user, such as a game controller/input device, this system can provide an interesting “human interface” for gaming/training/simulation. User can play games/training against machine, or vs. other game player in the scene or via network in the variant G force environment as required by the game/training content. The power assist means/robotic displacement devices in the system in this situation can also be used to provide “force feed back”. Communications between the exoskeleton controller and the game controllers is necessary in such conditions, and beside using the position information provided by the power assist means and treated as an “input only device”, force feedback signals, now commonly in game and training, can be send to actuators of the power assist means (such as an exoskeleton) to provide appropriate force feedback to user.

Thus optionally one or more interface(s) to the control system of the buoyancy means and/or power assist means can be exposed to provide measurement, control, feedback, communication services and facilitate the integration with virtual reality system, game, training system, remote (internet) connections and etc.

To create a immersive simulation for the extraterrestrial Zero/Low Gravity environment, it is desirable that Virtual Reality systems or Mixed Reality system be used together with the buoyancy system and power assist system, to provide visual and audio simulation that is consistence with the scene and situation that the buoyancy system and power assist system is simulating.

Organizations such as NASA have engaged in the use of neutral buoyancy to simulate 0 gravity. When the force feelings provided by the combination of the buoyancy means and power assist means are confirmed by the surrounding visual cues provided by the VR/MR/AR system, the total immersive sensation of the “virtual world” being simulated may be achieved. Accordingly, some embodiments of the invention provide simulations that will engage the user's tactile and hearing sense in a manner consistent with the visual display and surrounding visual cues provided by the VR/MR/AR system.

The user may be provided with a hand controller/manipulator/input device to control the display, to access their communication systems, or control or provide input in training/simulation or participating in a game.

In some embodiments the head mounted display may be provided with a camera so that the user can view objects in their surroundings. In those embodiments a computer system can switch or alter the view of user in the head mounted display such that the user can obtain the appropriate sensations that simulates user physically working on or with systems physically in his or her environment while maintaining the sensation of being in the virtual environment.

In some embodiments using Mixed reality and AR, the MR/AR system may require a clean “background” for visual signal mixing (chroma keying). Basically it requires a solid color (such as green) background in the field of view (FOV) of the camera against the foreground “people” or “user's hand/feet” that is captured by the same camera. Mixed reality image processing engine later can substitute the “green background” with other images such as the images of the virtual world being simulated. In these cases, the supporting structures that needs to be hide in the simulation images usually needs to be surround by curve shaped surfaces with either light absorbing materials or painted into solid color so that they can be filtered out by the MR image mixing process.

In some embodiments the external display may be provided in such a format that surrounds the user so that the user feels as though he or she is in the environment being simulated. To achieve this sensation the external screen may be displayed on the sidewalls and the bottom surface of the surrounding environment and or the surrounding environment may have a spherical shape, with no apparent edges in the user's field of view. The environment may be structured to provide a display as in a cave automatic virtual environment, also known as “CAVE”, wherein the visual display is provided on multiple walls of the environment so that the user is surrounded by the virtual environment and has a more realistic sensation of being immersed in the environment depicted by the virtual environment.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. An apparatus for variable G force experience and to create immersive VR sensations comprise of:
A “Buoyancy means” which utilizing fluid or mixture of fluids for body weight support of the subject, such “Buoyancy means” has a flexible inner surface/layer which is relatively impermeable to the fluid/mixture of fluids being used and covers or “wraps” substantially the subject's whole body area. It also has at least one outer surface layer to hold or to “contain” the fluids or mixture of fluids that used to “float” the subject inside the inner layer. The shape of the outer layer can be but not limited to suit shape or partially like suit shape. There could be multiple compartments to contain the fluids/mixture within the 2 surfaces/layers. Substantial area of inner layer should be able to provide fluid pressure to the subject.
A “power assist means” or “robotic displacement device” for subject, (such as but not limited to an exoskeleton) that integrate/couple with said “Buoyancy means” to help subject's movement/activity and/or relief or change loads on the subject's torso and limbs that caused by the weight and shape of the “Buoyancy means”, this could be in form of such as but not limited to gravity compensation, different G-force effect simulation and etc, while subject occupies the “buoyancy means”.

2. An apparatus according to claiml, wherein the “buoyancy means” can have multi part and individual parts optionally can be filled, drained and/or pressurized separately.

3. An apparatus according to claiml, wherein fluid between the inner layer and outside layer can be moved in and out, and could be dynamically while subject occupies the “buoyancy means”

4. An apparatus according to claim 1, wherein the “buoyancy means” and robotic displacement/power assist devices can be made into appropriate size and shape, and being fitted into a larger outer suit/figure which can look like for example but not limited to a space suit, a figure of species or creature bearing resemblance with human shape, and etc.

5. An apparatus according to claiml, wherein virtual reality systems, augmented reality systems or mixed reality systems (may including display means, image processing unit, possible image capture devices and etc.) can be integrate with the buoyancy means and power assist means, to provide synchronized visual and possibly audio experience to the subject, such experience is consistence with the scene/situation/environment that the buoyancy system and power assist system is simulating.

6. An apparatus according to claiml, wherein that Buoyancy means and power assisting means can further integrated the with game controller, manipulator or other user input device for the purpose such as but not limited to game, training, entertainment, simulation, healing and etc.

7. An apparatus according to claim 1, wherein the “power assist means” or “robotic displacement device” can be used to produce (additional) tactile or force feedback to the user by providing physical sensations to the user. Coordinated by the controlling unit of the “power assist means” or “robotic displacement device”, by changing for example (but not limited to) the factors/percentages of gravity compensation, possibly dynamically, to provide the feeling of variable G force effects. Other sensations such as vibration and “resisting” force can also be produced by for example changing the output of the “power assist means” or “robotic displacement device” on one or more actuators.

8. An apparatus according to claim 1, wherein force feedback can also be produced by varying/changing the pressure of different compartment of the Buoyancy means.

9. An apparatus according to claim 1, wherein additional tactile devices as well as motion sensors on or near user's body can be used to increase the accuracy and/or fun of the force feedback sensation.

10. An apparatus according to claim 1, wherein one or more interface(s) to the control system of the buoyancy means and/or power assist means can be exposed/provided to provide measurement, control, feedback, communication services and facilitate the integration with virtual reality system, game, training system, remote (internet) connections and etc.

11. An method to provide user with variable G force experience and create immersive VR sensations, the method comprising:
Having user don an “Buoyancy means” that support for his/her body weight by the pressure/buoyancy generated by the fluid/mixture of fluids, such “Buoyancy means” has a flexible inner surface/layer which is relatively impermeable to the fluid/mixture of fluids being used and covers or “wraps” substantially the users whole body area. It also has at least one outer layer/surface to hold or to “contain” fluids/mixture that used to “float” the subject inside the inner layer. The shape of the outer layer can be but not limited to suit shape or partially like suit shape. There could be multiple compartments to contain the fluids/mixture within the 2 surfaces/layers. Substantial area of inner layer should be able to provide fluid pressure to the subject. While user occupies such “Buoyancy means” environment, using a “power assist means” or “robotic displacement device” (such as but not limited to exoskeleton) to help user's movement/activity and/or to relief or change loads on the subject's torso and limbs that caused by the weight and shape of the “Buoyancy means”, such as but not limited to providing gravity compensation, simulating different G-force effect or providing force feedback and etc, such “power assist means” is couple-able with the “Buoyancy means”.

12. A method according to claim 11, further comprising:
making the “buoyancy means” multi part, and filling, draining and/or pressurizing individual parts.

13. A method according to claim 11, further comprising:
moving fluid in and out of the space between the inner layer and outside layer, possibility dynamically.

14. A method according to claim 11, further comprising:
Fitting the “buoyancy means” and Robotic displacement/power assist devices into a larger outer suit which can look like for example but not limited to a space suit, a figure of species or creature bearing resemblance with human shape, and etc.

15. An method according to claim 11, further comprising:
integrating virtual reality systems, augmented reality systems or mixed reality systems (may including display means, image processing unit, possible image capture devices and etc.) with the buoyancy means and power assist means, to provide synchronized visual and possibly audio experience to the subject that is consistence with the scene/situation/environment that the buoyancy system and power assist system is simulating.

16. An method according to claim 11, further comprising:
integrating buoyancy means and power assisting means with game controller, manipulator or other user input device for the purpose such as but not limited to game, training, entertainment, simulation, healing and etc.

17. An method according to claim 11, further comprising:
producing (additional) tactile or force feedback to the subject by providing physical sensations to the subject with the “power assist means” or “robotic displacement device”. Coordinated by the controlling unit of the “power assist means” or “robotic displacement device”, by changing for example (but not limited to) the factors/percentages of gravity compensation, possibly dynamically, to achieve variable G force effect (sensation) to the subject. And/Or, for example by changing the output of the “power assist means” or “robotic displacement device” on one or more actuators to provide other forms such as vibration and/or “resisting” force to subject.

18. An method according to claim 11, further comprising:
varying/changing the pressure of different compartment of the Buoyancy means to achieve force feedback to subject.

19. An method according to claim 11, further comprising:
integrating additional tactile devices as well as motion sensors on or near user's body to increase the accuracy and/or fun of the force feedback sensation.

20. An method according to claim 11, further comprising:
exposing/providing one or more interface(s) to the control system of the buoyancy means and/or power assist means to provide measurement, control, feedback, communication services and facilitate the integration with virtual reality system, game, training system, remote (internet) connections and etc.
